(19) United States
(12) Patent Application Publication
(10) Pub. No.: US 2017/0185159 A1
(43) Pub. Date: Jun. 29, 2017

(54) DETECTION DEVICE, DETECTION METHOD, AND COMPUTER READABLE STORAGE MEDIUM

(71) Applicant: FUJITSU LIMITED, Kawasaki-shi (JP)

(72) Inventors: Yuichi Murase, Yokohama (JP); Hiroshi Hidaka, Kawasaki (JP)

(73) Assignee: FUJITSU LIMITED, Kawasaki-shi (JP)

(21) Appl. No.: 15/383,142

(22) Filed: Dec. 19, 2016

(30) Foreign Application Priority Data
Dec. 24, 2015 (JP) 2015-252108

(51) Int. Cl. G06F 3/01; G06F 1/16; G06F 3/03

(52) U.S. Cl. CPC G06F 3/017; G06F 3/0325; G06F 3/011; G06F 1/163

(57) ABSTRACT

A detection device including: a sensor configured to emit a light and detect an object by detecting the light reflected from the object, and a processor configured to determine, when the object is detected in a first region that is narrower than a range where the light reaches, a motion of the object to be a gesture input for the detection device.

### CROSS-REFERENCE TO RELATED APPLICATION

This application is based upon and claims the benefit of priority of the prior Japanese Patent Application No. 2015-252108, filed on Dec. 24, 2015, the entire contents of which are incorporated herein by reference.

### FIELD

Disclosed techniques are related to a detection device, a detection method, and a detection program.

### BACKGROUND

In recent years, application of a wearable display device such as a head mounted display (HMD) has been being promoted as a measure to view information at a site of work. At a site where a worker who carries out input operation to an operation screen displayed on the HMD or the like frequently wears a work glove or the like, it is difficult to carry out the input operation by operating an input device such as a touch panel. Therefore, a user interface (UI) with which input operation may be carried out without directly operating an input device such as a touch panel may be required.

As one UI, a gesture input method in which a finger, a hand, or the like that makes a gesture representing input operation is shot by a camera and the gesture is recognized from the shot image has been proposed. However, at a site of work, it is sometimes difficult to stably carry out the gesture input due to the influence of the movement of the worker, change in the posture of the worker, environmental conditions such as the background color and illumination, and so forth.

Therefore, a technique in which gesture input is carried out by using a laser sensor that is robust regarding the environmental conditions such as illumination has been proposed.

For example, there has been proposed a control device based on gesture recognition in which the existence position of a detection-target object is detected from a distance measured by a laser range sensor that measures the distance to the detection-target object that exists in a detection plane. In this control device, the motion of the detection-target object may be detected from time-series data of the detected existence position of the detection-target object and a gesture may be extracted from the motion of the detection-target object. Then, a control command according to the extracted gesture may be generated to be given to control target equipment.

Furthermore, there has been proposed a method in which a user blocks light from a laser tracker at least partly and thereby a temporal pattern corresponding to one command selected from plural commands by the user is generated.

### CITATION LIST

### Patent Documents

[Patent Document 1] Japanese Laid-open Patent Publication No. 2010-244480

[Patent Document 2] Japanese Laid-open Patent Publication No. 2013-145240

### SUMMARY

According to an aspect of the embodiments, a detection device includes a sensor configured to emit a light and detect an object by detecting the light reflected from the object, and a processor configured to determine, when the object is detected in a first region that is narrower than a range where the light reaches, a motion of the object to be a gesture input for the detection device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating schematic configurations of gesture input systems according to first and second embodiments;

FIG. 2 is a diagram illustrating one example of mounting of mounted equipment on a user;

FIG. 3 is a diagram illustrating another example of mounting of mounted equipment on a user;

FIG. 4 is a diagram for explaining setting of a gesture region;

FIG. 5 is a diagram for explaining setting of a gesture region according to change in posture;

FIG. 6 is a diagram illustrating one example of an operation screen;

FIG. 7 is a block diagram illustrating a schematic configuration of a computer that functions as a detection device;

FIG. 8 is a flowchart illustrating one example of detection processing in the first embodiment;

FIG. 9 is a diagram illustrating one example of parameters for setting a gesture region;

FIG. 10 is a diagram illustrating a relationship among parameters for setting a gesture region;

FIG. 11 is a schematic diagram of one example of a measurement result;

FIG. 12 is a diagram for explaining gesture recognition;

FIG. 13 is a diagram for explaining setting of a gesture start preparation region and a gesture end region;

FIG. 14 is a diagram illustrating one example of parameters for setting a gesture start preparation region and a gesture end region;

FIG. 15 is a diagram for explaining detection of an instructing body in the second embodiment;

FIG. 16 is a flowchart illustrating one example of detection processing in the second embodiment;

FIG. 17 is a block diagram illustrating a schematic configuration of a gesture input system according to a third embodiment;

FIG. 18 is a diagram for explaining one example of environment recognition; and

FIG. 19 is a flowchart illustrating one example of environment recognition processing.

### DESCRIPTION OF EMBODIMENTS

In the method in which a detection-target object is detected by a laser range sensor, it is difficult to identify whether an object existing in a detection plane is an instructing body (object such a hand or a finger) that makes an instruction of an input by a gesture or an object other than the instructing body.

Furthermore, the laser range sensor or the like may be set on the environment side. However, at a site of work, it is preferable that gesture input may be carried out not at a fixed place but at arbitrary various places. Therefore, for example, it is conceivable that a worker wears the laser range sensor and thereby the gesture input at arbitrary places is enabled.

However, in this case, the possibility that an object other than the instructing body that makes an instruction of an input enters the detection plane of the laser range sensor becomes higher. As a result, there is a possibility that an object existing in the detection plane is detected as the instructing body although being an object other than the instructing body. Furthermore, the case in which the instructing body enters the detection plane although a gesture input is not intended is also envisaged. Also in this case, there is a possibility that this instructing body is detected as the instructing body although this instructing body is preferably not detected as the instructing body.

Disclosed techniques intend to stably detect the instructing body that makes an instruction of an input as one aspect.

One example of embodiments according to the disclosed techniques will be described in detail below with reference to the drawings.

### First Embodiment

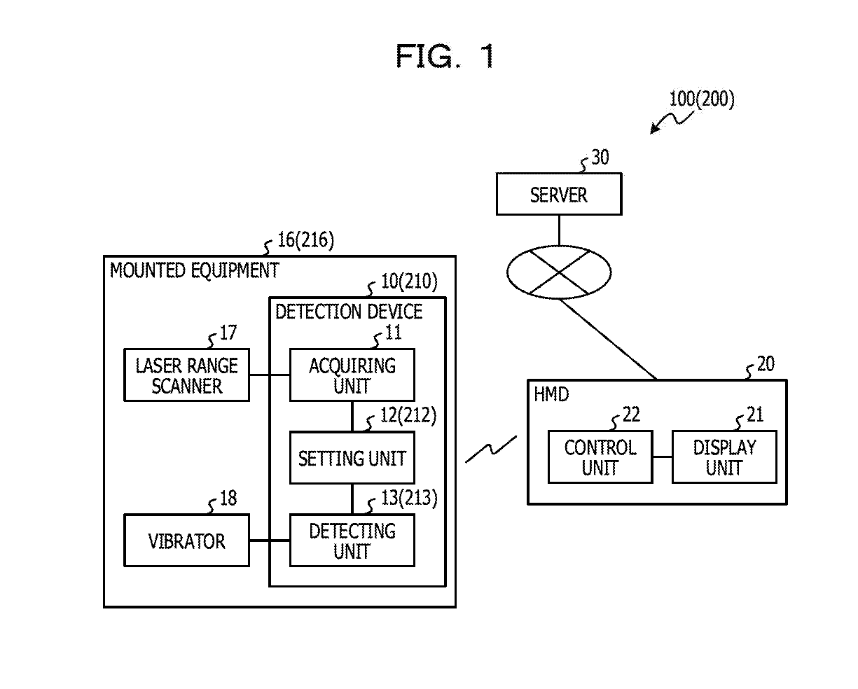

As illustrated in FIG. 1, a gesture input system 100 according to a first embodiment includes mounted equipment 16, an HMD 20, and a server 30. In the gesture input system 100, a gesture input carried out by a user who wears the mounted equipment 16 to an operation screen displayed on the HMD 20 based on information provided from the server 30 is accepted. The mounted equipment 16 and the HMD 20 are coupled by short distance wireless communication or the like, for example. The HMD 20 and the server 30 are coupled via a network such as the Internet.

The mounted equipment 16 includes a detection device 10, a laser range scanner 17, and a vibrator 18 that is a vibration mechanism to give vibrations to the mounted equipment 16.

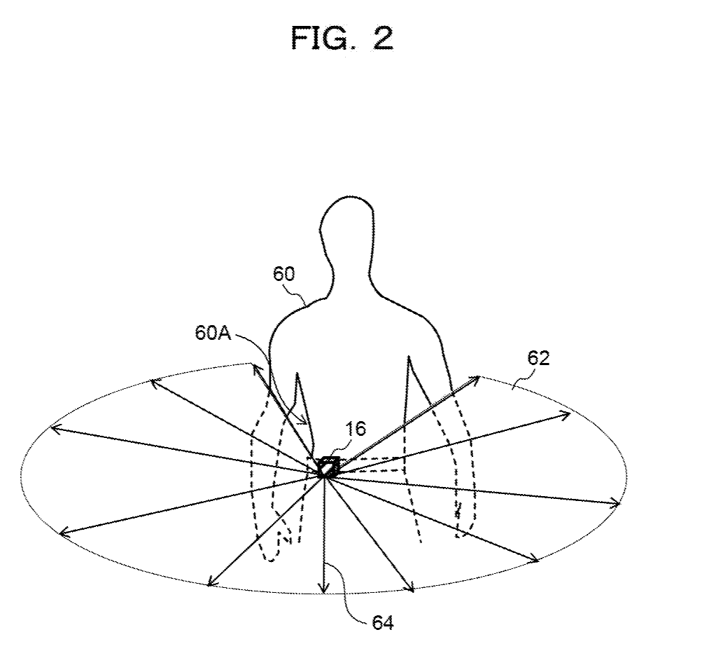

The mounted equipment 16 is mounted on part of the body of a user 60. For example, as illustrated in FIG. 2, the mounted equipment 16 may be mounted on a body trunk 60A (for example, waist) of the user 60 by being fixed to a belt or the like or being directly attached to clothing.

The laser range scanner 17 is a measurement device of a plane scanning type that measures the distance to an object existing in the surroundings. For example, the laser range scanner 17 includes an emitting unit that emits light such as laser light with scanning in given directions, a light receiving unit that receives reflected light obtained by reflection of the light emitted from the emitting unit by an object existing in the measurement range, and an output unit that outputs the measurement result.

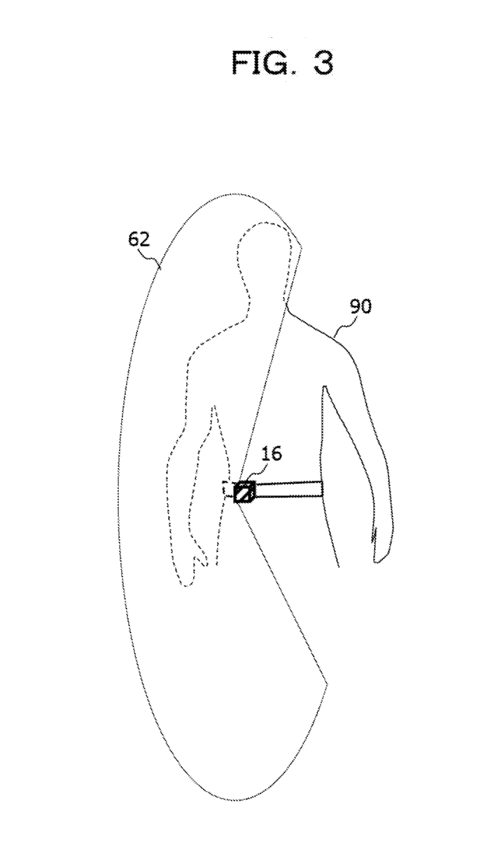

A measurement range 62 is a plane defined by an aggregation of vectors 64 indicating the emission direction of one time of light emission by the emitting unit corresponding to one scan as illustrated in FIG. 2. In the example of FIG. 2, the case in which the scanning direction of light by the emitting unit of the laser range scanner 17 is substantially the horizontal direction is illustrated. Therefore, the measurement range 62 is also defined as a plane along substantially the horizontal direction. Furthermore, as illustrated in FIG. 3, if the scanning direction of light by the emitting unit of the laser range scanner 17 is substantially the vertical direction, the measurement range 62 is also defined as a plane along substantially the vertical direction. However, the measurement range 62 is not limited to the case in which the measurement range 62 is defined as a plane along substantially the horizontal direction or substantially the vertical direction and may be defined as a plane having an inclination in the horizontal direction or the vertical direction.

Moreover, the output unit calculates a distance d to a position on an object by which emitted light is reflected based on the time from the emission of the light from the emitting unit to reception of the reflected light by the light receiving unit, and acquires an angle θ when the reflected light from the position is incident on the light receiving unit. Then, the output unit outputs data (d, θ) of the combination of the distance d and the angle θ as the measurement result, for example. If M times of light emission are carried out in one time of scanning, the output unit outputs M pieces of data (d, θ) as the measurement result corresponding to the one time of scanning. This measurement result represents the position of the object in the measurement range 62.

As illustrated in FIG. 1, the detection device 10 includes an acquiring unit 11, a setting unit 12, and a detecting unit 13 functionally.

The acquiring unit 11 accepts the measurement result output from the laser range scanner 17 and transfers the measurement result to the setting unit 12.

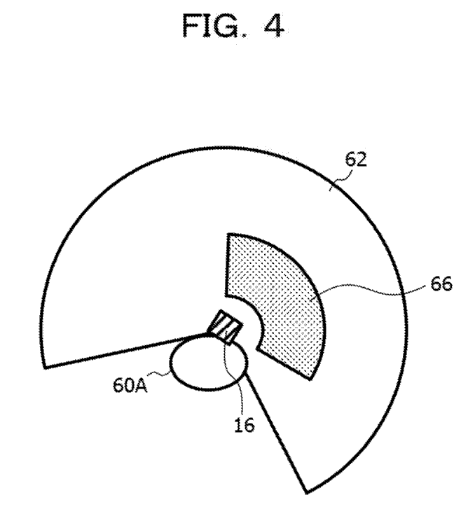

The setting unit 12 sets a gesture region 66 defined with envisaging of a region in which an instructing body that makes an input instruction acts in the measurement range 62 of the laser range scanner 17. For example, suppose that the instructing body that makes an input instruction is the right hand part of the user 60 in the case in which the mounted equipment 16 is mounted on the body trunk 60A of the user 60 as illustrated in FIG. 2 and the measurement range 62 is along substantially the horizontal direction. In the present embodiment, a range including the region from the upper arm to the fingertips of the user 60 will be referred to as the hand part. In this case, for example, as illustrated in FIG. 4, the range the right hand part is able to reach from the body trunk 60A may be set as the gesture region 66. FIG. 4 is a schematic diagram when the user 60 who wears the mounted equipment 16 and the measurement range 62 are viewed from above and the right side on the plane of paper is the right hand side of the user 60.

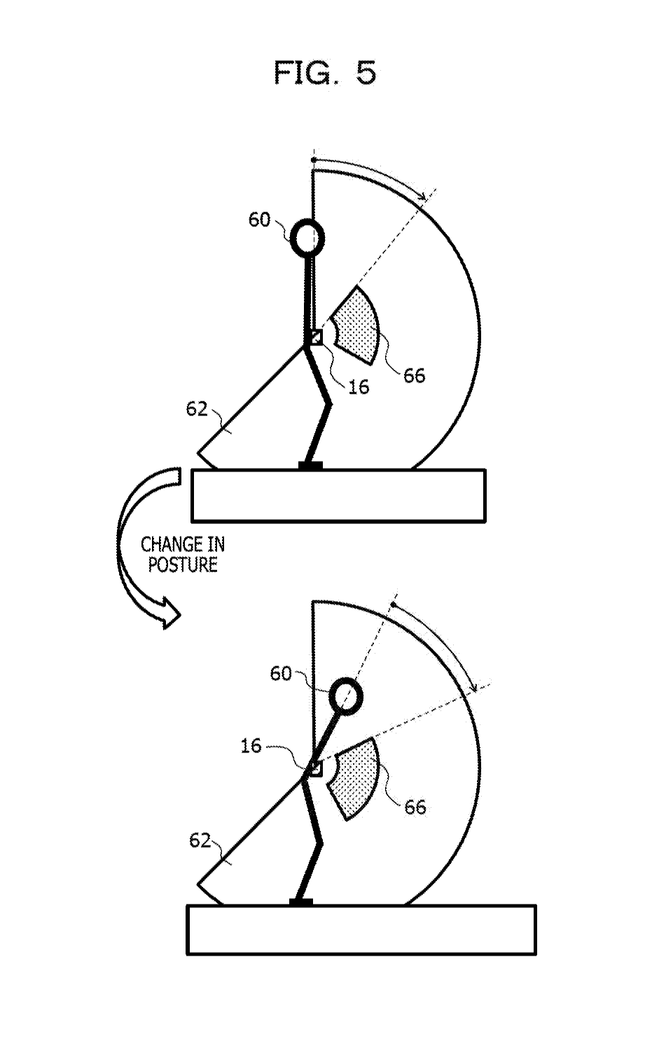

Here, for example, as illustrated in FIG. 5, the measurement range 62 of the laser range scanner 17 included in the mounted equipment 16 is poorly affected by change in the posture of the user 60 if the mounted equipment 16 is mounted on the body trunk 60A. On the other hand, when gesture input is carried out with the hand part of the user 60, if the posture of the user 60 changes, particularly if the posture of the upper body changes, the position at which the gesture is carried out with the hand part is readily affected by the change in the posture. Therefore, the setting unit 12 does not set the gesture region 66 fixed with respect to the measurement range 62 but sets the gesture region 66 depending on the change in the posture of the user 60. FIG. 5 is a schematic diagram when the user 60 who wears the mounted equipment 16 and the measurement range 62 are viewed from a lateral side in the case in which the measurement range 62 is along substantially the vertical direction.

The detecting unit 13 detects an object existing in the gesture region 66 as the instructing body that makes an input instruction based on the measurement result of the laser range scanner 17 and the gesture region 66 set by the setting unit 12. Furthermore, the detecting unit 13 recognizes a gesture based on the motion of the detected instructing body in the gesture region 66. The detecting unit 13 transmits the input instruction represented by the recognized gesture to the HMD 20.

Moreover, when detecting the instructing body in the gesture region 66, the detecting unit 13 causes the vibrator 18 to vibrate in order to notify the start of gesture recognition.

Details of the setting method of the gesture region 66 in the setting unit 12 and the recognition method of the gesture in the detecting unit 13 will be described later.

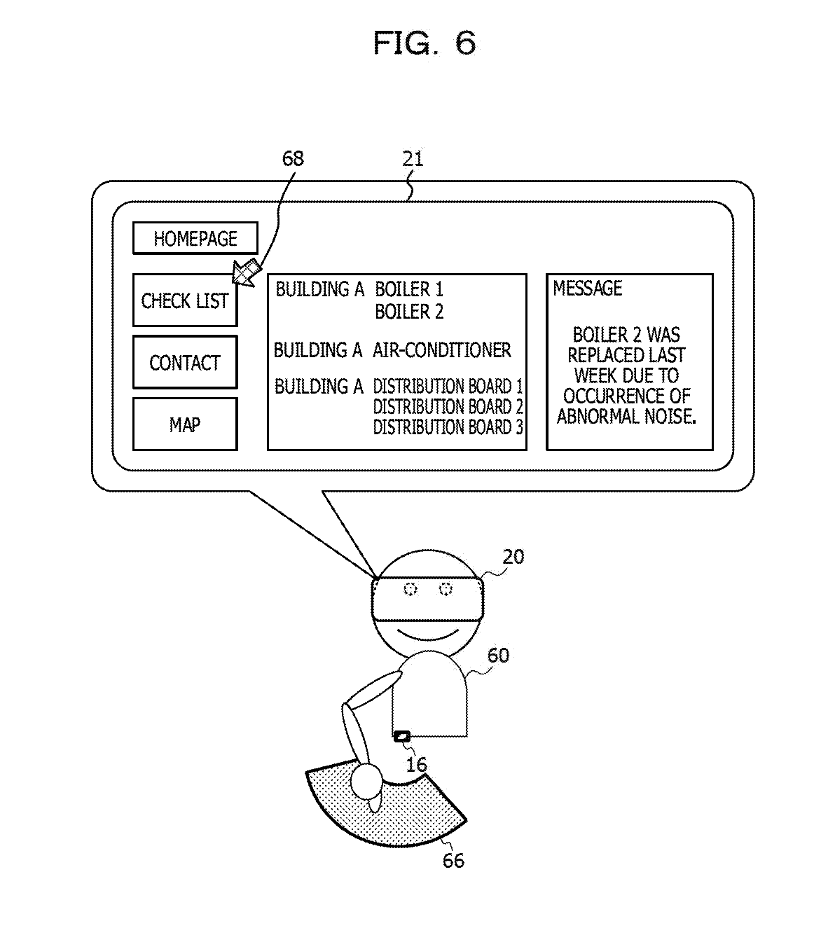

As illustrated in FIG. 1, the HMD 20 includes a display unit 21 on which various kinds of information are displayed and a control unit 22 that controls displaying of information to the display unit 21. On the display unit 21, for example, an operation screen like one illustrated in FIG. 6 is displayed based on information transmitted from the server 30. When the user 60 who wears the HMD 20 and the mounted equipment 16 makes a gesture in the gesture region 66, an input instruction is transmitted from the detecting unit 13 as described above. When accepting this input instruction, the control unit 22 carries out display control of the movement of a pointer 68 displayed on the display unit 21, highlighting of a selected item, or the like in accordance with the input instruction, for example. Furthermore, the control unit 22 transmits information on the selected item to the server 30. Moreover, the control unit 22 accepts information newly transmitted from the server 30 according to the selected item and carries out display control of the display unit 21.

The server 30 is an information processing device such as a personal computer or a server device.

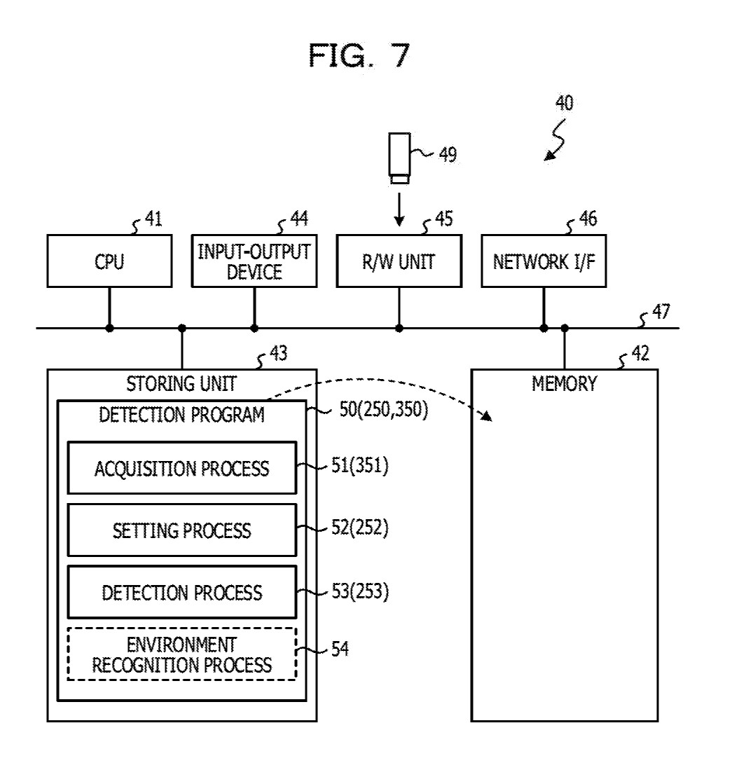

The detection device 10 included in the mounted equipment 16 may be implemented by a computer 40 illustrated in FIG. 7, for example. The computer 40 includes a central processing unit (CPU) 41, a memory 42 as a temporary storage area, and a non-volatile storing unit 43. Furthermore, the computer 40 includes an input-output device 44, a read/write (R/W) unit 45 that controls reading and writing of data from and to a recording medium 49, and a communication interface (I/F) 46. The CPU 41, the memory 42, the storing unit 43, the input-output device 44, the R/W unit 45, and the communication I/F 46 are coupled to each other via a bus 47.

The storing unit 43 may be implemented by a hard disk drive (HDD), a solid state drive (SSD), a flash memory, or the like. In the storing unit 43 as a storage medium, a detection program 50 for causing the computer 40 to function as the detection device 10 is stored. The detection program 50 includes an acquisition process 51, a setting process 52, and a detection process 53.

The CPU 41 reads out the detection program 50 from the storing unit 43 and loads the detection program 50 into the memory 42 to sequentially execute the processes the detection program 50 has. The CPU 41 operates as the acquiring unit 11 illustrated in FIG. 1 by executing the acquisition process 51. Furthermore, the CPU 41 operates as the setting unit 12 illustrated in FIG. 1 by executing the setting process 52. Moreover, the CPU 41 operates as the detecting unit 13 illustrated in FIG. 1 by executing the detection process 53. This causes the computer 40 that executes the detection program 50 to function as the detection device 10.

It is also possible that functions implemented by the detection program 50 are implemented by a semiconductor integrated circuit for example, an application specific integrated circuit (ASIC) or the like for more detail.

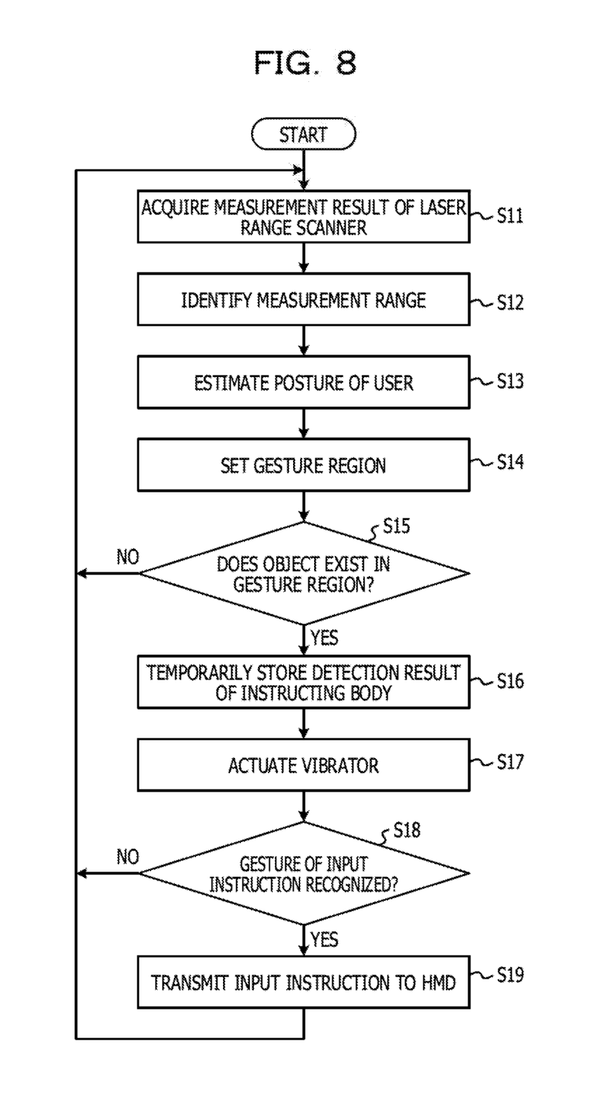

Next, operation of the gesture input system 100 according to the first embodiment will be described. The user 60 wears the mounted equipment 16 and the HMD 20. Then, when an application offered by the gesture input system 100 is activated, information representing an operation screen is transmitted from the server 30 to the HMD 20 and the operation screen is displayed on the display unit 21 of the HMD 20. Then, measurement and output of the measurement result by the laser range scanner 17 included in the mounted equipment 16 are started and detection processing illustrated in FIG. 8 is executed in the detection device 10.

First, in a step S11, the acquiring unit 11 accepts a measurement result output from the laser range scanner 17 and transfers the measurement result to the setting unit 12.

Next, in a step S12, the setting unit 12 identifies the measurement range 62 of the laser range scanner 17 based on the measurement result of the laser range scanner 17. For example, the setting unit 12 identifies whether the measurement range 62 of the laser range scanner 17 is the measurement range 62 along the horizontal direction like that illustrated in FIG. 2 or the measurement range 62 along the vertical direction like that illustrated in FIG. 3.

Next, in a step S13, the setting unit 12 estimates the posture of the user 60 based on the measurement result of the laser range scanner 17. For example, the setting unit 12 estimates the posture of the user 60 based on the position of a region 60B that is part of the body of the user 60 detected in the measurement range 62 and is other than the region serving as the instructing body. As the region 60B of the user 60, the left hand part or part of the body trunk 60A (for example, waist) may be employed if the mounted equipment 16 is mounted on the body trunk 60A and the measurement range 62 is along the horizontal direction and the instructing body is the right hand part, for example. Furthermore, as the region 60B of the user 60, the head or part of the body trunk 60A (for example, chest) may be employed if the mounted equipment 16 is mounted on the body trunk 60A and the measurement range 62 is along the vertical direction, for example. The measurement result of the laser range scanner 17 indicates the position of an object existing in the measurement range 62. In addition, from a succession of the position, the shape of the object surface on the side of the laser range scanner 17 may also be recognized. Therefore, the setting unit 12 identifies the region 60B from the inside of the measurement range 62 based on this shape of the object surface and estimates the position of the identified region 60B in the measurement range 62 as the posture of the user 60.

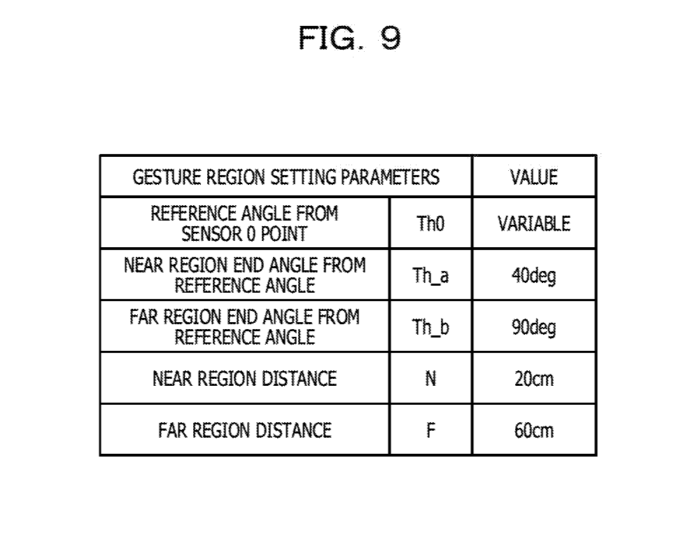

Next, in a step S14, the setting unit 12 sets the gesture region 66 based on parameters defined in advance in order to set the gesture region 66 as illustrated in FIG. 9 and the posture of the user estimated in the above-described step S13, for example.

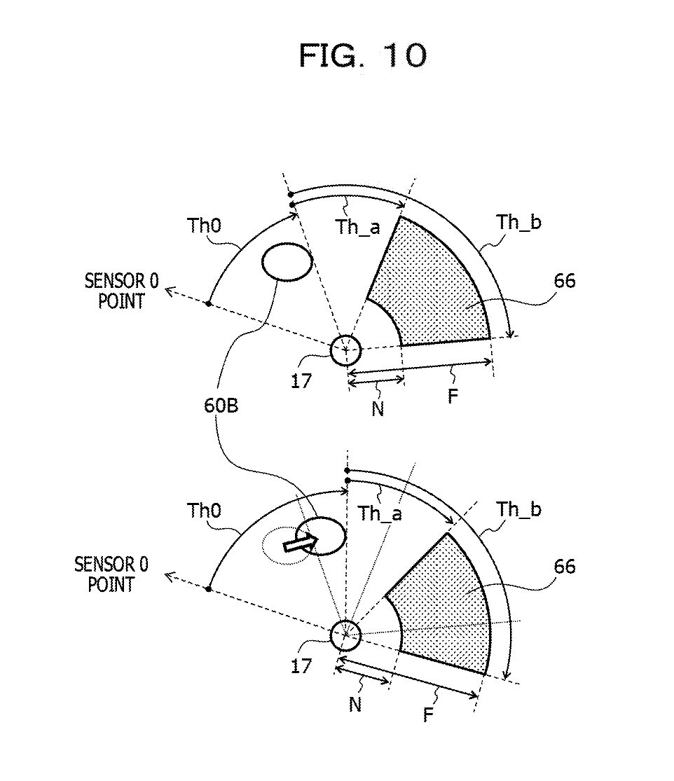

In the example of the parameters represented in FIG. 9, it is defined that the position of the region 60B when a sensor 0 point representing one limit point of the scanning direction of the laser range scanner 17 is defined as 0° is employed as a reference angle Th0. The position of the region 60B is displaced relative to the sensor 0 point and thus the reference angle Th0 is a variable. Furthermore, in the example of the parameters represented in FIG. 9, an angle (near region end angle) Th_a from the reference angle Th0 to the near end part of the gesture region 66 and an angle (far region end angle) Th_b to the far end part are defined. Moreover, in the example of the parameters represented in FIG. 9, a distance (near region distance) N from the laser range scanner 17 to the near end part of the gesture region 66 and a distance (far region distance) F to the far end part are defined. In FIG. 10, the relationship among the laser range scanner 17, the sensor 0 point, and the parameters Th0, Th_a, Th_b, N, and F is illustrated.

Here, when the posture of the user 60 changes, the region 60B of the user 60 with respect to the sensor 0 point is also displaced. Therefore, by employing a variable according to the region 60B as the reference angle Th0 for defining the gesture region 66, when the posture of the user 60 changes, the position of the set gesture region 66 also changes as illustrated in FIG. 10.

Furthermore, the proper setting position of the gesture region 66 differs depending on to what region of the user 60 and toward which direction the mounted equipment 16 including the laser range scanner 17 is attached. Therefore, a table like that illustrated in FIG. 9 is prepared for each of the measurement ranges 62 corresponding to patterns different from each other in the attachment position and attachment direction of the mounted equipment 16. Then, the parameters Th0, Th_a, Th_b, N, and F for identifying the optimum gesture region 66 when the mounted equipment 16 is attached with the pattern corresponding to a respective one of the measurement ranges 62 are defined for each of the measurement ranges 62 corresponding to a respective one of the patterns. Furthermore, the setting unit 12 selects the table corresponding to the measurement range 62 identified in the step S12 to acquire the parameters, and sets the gesture region 66 based on the acquired parameters.

Next, in a step S15, the detecting unit 13 determines whether or not an object exists in the gesture region 66 based on the measurement result of the laser range scanner 17 and the gesture region 66 set in the above-described step S14. The detecting unit 13 determines that an object exists in the gesture region 66 if a position included in the gesture region 66 defined by the above-described parameters exists among positions represented by plural pieces of data (d, θ) as measurement results of the laser range scanner 17. For example, suppose that the gesture region 66 is defined with Th0=30 degrees, Th_a=40 degrees, Th_b=90 degrees, N=20 cm, and F=60 cm. In this case, if data of (d, θ)=(40 cm, 80 degrees) exists in measurement results of the laser range scanner 17, the position represented by (d, θ) is in the gesture region 66 and thus the detecting unit 13 determines that an object exists in the gesture region 66. θ is an angle of the clockwise direction from the sensor 0 point.

Then, if an object exists in the gesture region 66, the detecting unit 13 detects the object as an instructing body 70 that makes an input instruction and the processing makes transition to a step S16. On the other hand, if an object does not exist in the gesture region 66, the processing returns to the step S11.

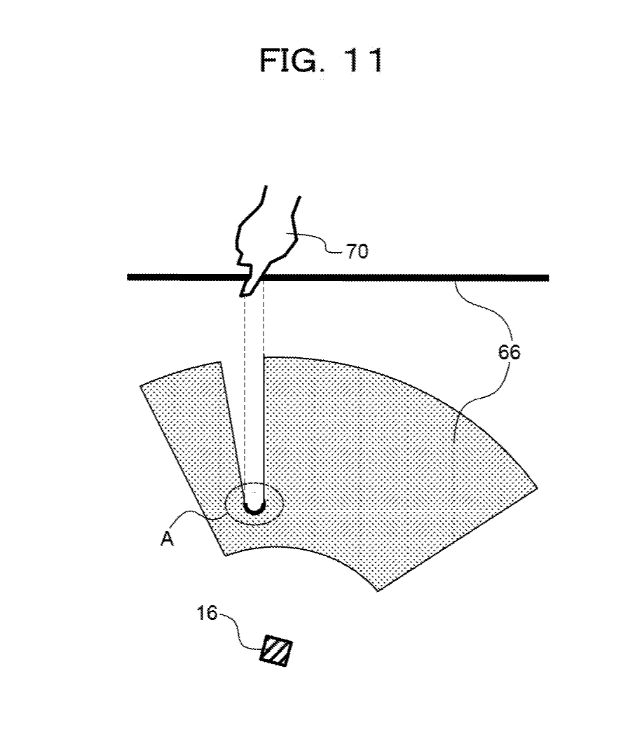

In the step S16, the detecting unit 13 temporarily stores the detection result of the above-described step S15 in a given storage area. In this storage area, detection results of a given time are stored. The detection result of the object is represented as one shape like a heavy line part in an ellipse A in FIG. 11 through succession of plural measurement results (d, θ). Therefore, the detecting unit 13 stores the measurement result group representing this one shape as the detection result representing one instructing body 70. Furthermore, if plural instructing bodies 70 are detected in the gesture region 66, identification information is given to each instructing body 70 and the detection result is stored about each of the instructing bodies 70.

Next, in a step S17, the detecting unit 13 causes the vibrator 18 to vibrate in order to notify the start of gesture recognition.

Next, in a step S18, the detecting unit 13 recognizes whether or not the motion of the instructing body 70 is a gesture defined in advance as an input instruction to the operation screen displayed on the display unit 21 of the HMD 20, based on time-series change in the detection result of the instructing body 70 stored in the given storage area.

As gestures of the input instruction, a gesture of a direction instruction, gestures of a tap and a double tap, and so forth may be defined, for example. The recognition method of the respective gestures will be described below.

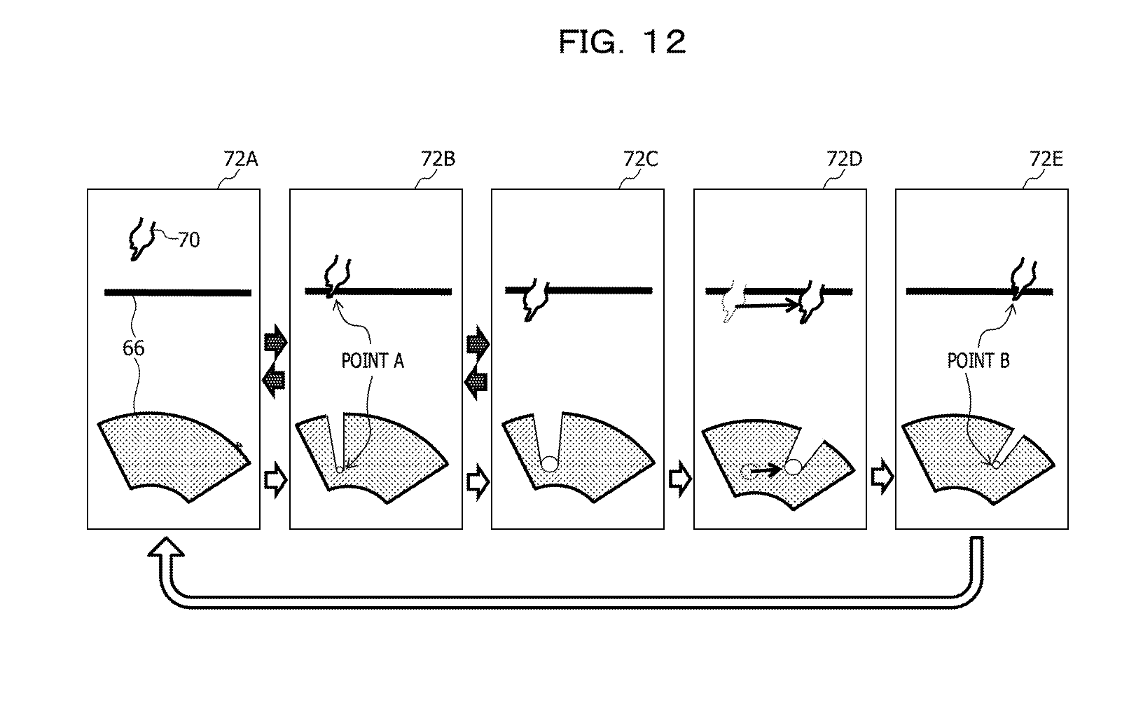

In FIG. 12, one example of gesture recognition is schematically illustrated. The example of FIG. 12 represents that the instructing body 70 is a hand part with a pointing pose and the instructing body 70 enters the gesture region 66 at point A (72B) from the state in which the instructing body 70 has not entered the gesture region 66 (72A). Furthermore, the example of FIG. 12 represents that the instructing body 70 moves from point A to point B in the gesture region 66 (72C→72D) and exits from the gesture region 66 at point B (72E). Moreover, in 72C of FIG. 12, it is represented that the size of the detected instructing body 70 is large compared with in 72B. This represents that, first, a small section (equivalent to the heavy line part in the ellipse A in FIG. 11) is detected when the fingertip enters the gesture region 66 and then a region such as a wrist, whose section is larger than the fingertip, is detected through further advancement of the hand part in such a direction as to pass through the gesture region 66. As the size of the section, the number of measurement results included in the measurement result group stored as the detection result of one instructing body 70, the length of the shape represented by the measurement result group, the area of a sectional shape estimated from the shape represented by the measurement result group, and so forth may be used. In addition, in 72E of FIG. 12, it is represented that the size of the detected instructing body 70 is small compared with in 72D.

Suppose that the detection result of the instructing body 70 stored in the given storage area represents time-series change of 72A→72B→72C→72D→72E→72A in FIG. 12 (flow of white block arrows in FIG. 12). In this case, the detecting unit 13 may recognize that the motion of the instructing body 70 is a gesture of a direction instruction between point A and point B. Furthermore, suppose that the detection result of the instructing body 70 represents time-series change of 72A→72B→72C→72B→72A in FIG. 12 (flow of hatched block arrows in FIG. 12). In this case, the detecting unit 13 may recognize that the motion of the instructing body 70 is a gesture of a tap at point A. Furthermore, if a similar tap action is repeated twice in a short time, the detecting unit 13 may recognize the motion of the instructing body 70 as a double tap.

If plural instructing bodies 70 have been detected in the step S15, the position and size of the instructing body 70 are compared between the detection result of the previous time and the detection result of the present time, and the instructing bodies 70 estimated to be the same are associated between the times and are given the same identification information. Then, the motion of each instructing body 70 is identified from time-series change in the detection result given the same identification information.

If the detecting unit 13 recognizes a gesture of an input instruction, the processing makes transition to a step S19. If a gesture of an input instruction is not recognized, the processing returns to the step S11.

In the step S19, the detecting unit 13 transmits the input instruction represented by the gesture recognized in the above-described step S18 to the HMD 20 and the processing returns to the step S11.

Due to this, in the HMD 20, the control unit 22 carries out display control of the movement of the pointer 68 displayed on the display unit 21, highlighting of a selected item, or the like based on the input instruction accepted from the detecting unit 13, for example. Then, the control unit 22 transmits information on the selected item to the server 30.

The server 30 transmits information according to the item selected by the user 60 to the HMD 20 based on the information accepted from the control unit 22. In the HMD 20, the control unit 22 accepts the newly-transmitted information and carries out display control of the display unit 21 based on the accepted information.

As described above, according to the gesture input system 100 in accordance with the first embodiment, the user 60 wears the mounted equipment 16 including the laser range scanner 17. Furthermore, the detection device 10 included in the mounted equipment 16 sets, as the gesture region 66, a region in which an instructing body 70 that makes an input instruction is conceived to make a gesture in the measurement range 62 of the laser range scanner 17. Moreover, the detection device 10 detects an object existing in the set gesture region 66 as the instructing body 70 and recognizes a gesture representing an input instruction based on the motion of the instructing body 70 in the gesture region 66. Due to this, even when an object other than the instructing body 70 or the instructing body 70 that does not intend a gesture of an input instruction enters the measurement range 62 of the laser range scanner 17, the object or the instructing body 70 is not detected as the instructing body 70 that makes an input instruction if it is not in the gesture region 66. Therefore, the instructing body 70 may be stably detected.

Furthermore, according to the detection device 10 in accordance with the first embodiment, the gesture region 66 is set at a proper position according to the posture of the user 60 who wears the mounted equipment 16 including the laser range scanner 17. Therefore, the instructing body 70 may be stably detected even in work involving posture change.

### Second Embodiment

Next, a second embodiment will be described. Regarding a gesture input system according to the second embodiment, the part similar to that of the gesture input system 100 according to the first embodiment is given the same numeral and detailed description of the part is omitted.

In the first embodiment, description is made about the case in which, if an object exists in the gesture region 66 set by the setting unit 12, the object is detected as the instructing body 70 that makes an input instruction. In this case, also when an object other than the instructing body 70 or the instructing body 70 that does not intend a gesture of an input instruction enters the gesture region 66, the object or the instructing body 70 is detected as the instructing body 70 that makes an input instruction. If the detected instructing body 70 is an object other than the instructing body 70 or the instructing body 70 that does not intend a gesture of an input instruction, the possibility that these objects make an action similar to a gesture representing an input instruction defined in advance will be low. Therefore, the possibility that a problem of erroneous recognition of a gesture occurs will also be low, and processing of unnecessary gesture recognition occurs regarding the object other than the instructing body 70 and the instructing body 70 that does not intend a gesture of an input instruction.

Therefore, in the second embodiment, a target whose gesture is to be recognized as the instructing body 70 among objects that have entered the gesture region 66 is limited so that processing of such unnecessary gesture recognition is reduced.

As illustrated in FIG. 1, a gesture input system 200 according to the second embodiment includes mounted equipment 216, the HMD 20, and the server 30. The mounted equipment 216 includes a detection device 210, the laser range scanner 17, and the vibrator 18. The detection device 210 functionally includes the acquiring unit 11, a setting unit 212, and a detecting unit 213.

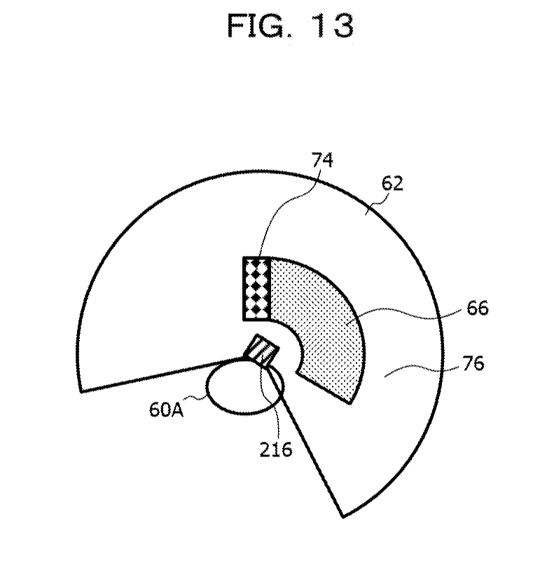

The setting unit 212 sets the gesture region 66 similarly to the setting unit 12 according to the first embodiment. Furthermore, as illustrated in FIG. 13, the setting unit 212 sets a partial region in contact with the gesture region 66 as a gesture start preparation region 74. The gesture start preparation region 74 is a region for determining to start gesture recognition by the detecting unit 213 when the instructing body 70 passes through this region and enters the gesture region 66. Therefore, a region through which entry into the gesture region 66 is difficult for an object other than the instructing body 70 and the instructing body 70 that does not intend a gesture of an input instruction is defined as the gesture start preparation region 74.

For example, suppose that a range the right hand part is able to reach from the body trunk 60A is set as the gesture region 66 as illustrated in FIG. 4. In this case, from the far side and the right side of the gesture region 66 as viewed from the body trunk 60A, an object other than the instructing body 70 will readily enter the gesture region 66. Furthermore, from the near side of the gesture region 66, the instructing body 70 that does not intend a gesture of an input instruction will readily enter the gesture region 66 due to a swing of a hand in normal walking or the like. Therefore, the setting unit 212 may set the gesture start preparation region 74 at the left end part of the gesture region 66 as illustrated in FIG. 13, for example.

Furthermore, as illustrated in FIG. 13, the setting unit 212 sets at least a partial region in contact with the gesture region 66 as a gesture end region 76. The gesture end region 76 is a region for determining the end of the gesture recognition by the detecting unit 213 when the instructing body 70 moves from the gesture region 66 to this region. For example, the setting unit 212 may set the gesture end region 76 around the gesture region 66 as illustrated in FIG. 13.

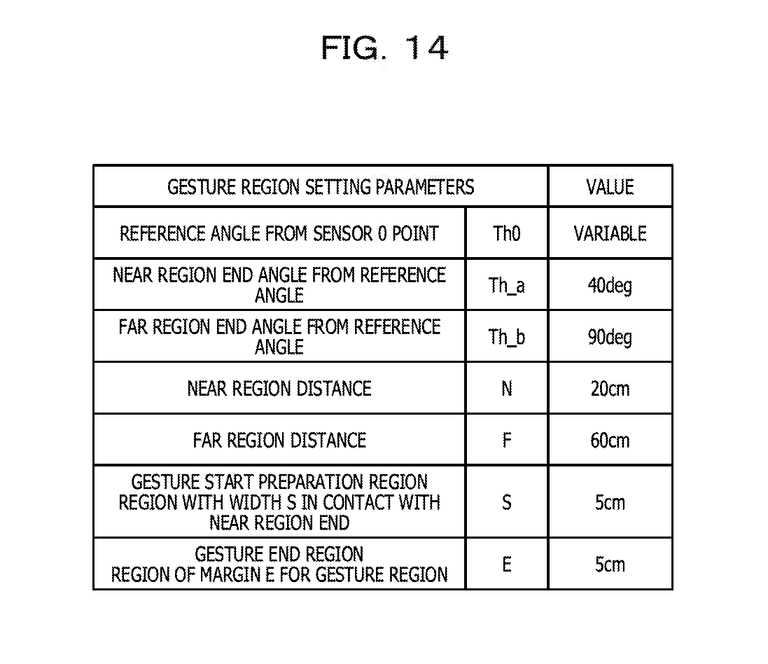

For example, as illustrated in FIG. 14, parameters for setting each of the gesture start preparation region 74 and the gesture end region 76 are defined in addition to the parameters for setting the gesture region 66. In the example of FIG. 14, it is defined that a region with a width S having the end part of the gesture region 66 on the side closer to the sensor 0 point as one side is employed as the gesture start preparation region 74. Furthermore, it is defined that a region that is a region outside the gesture region 66 and corresponds to a margin E from the gesture region 66 is employed as the gesture end region 76.

In the case of using the parameters of FIG. 14, the setting unit 212 sets the gesture region 66 based on the parameters Th0, Th_a, Th_b, N, and F similarly to the setting unit 12 in the first embodiment. Furthermore, based on the set gesture region 66, the setting unit 212 sets each of the gesture start preparation region 74 and the gesture end region 76 based on each of the parameters S and E.

The detecting unit 213 detects, as the instructing body 70, an object that passes through the gesture start preparation region 74 set by the setting unit 212 and enters the gesture region 66. Then, the detecting unit 213 carries out gesture recognition regarding the detected instructing body 70 similarly to the detecting unit 13 in the first embodiment. Furthermore, the detecting unit 213 ends the recognition of a gesture and the detection of the instructing body 70 if the instructing body 70 moves from the gesture region 66 to the gesture end region 76.

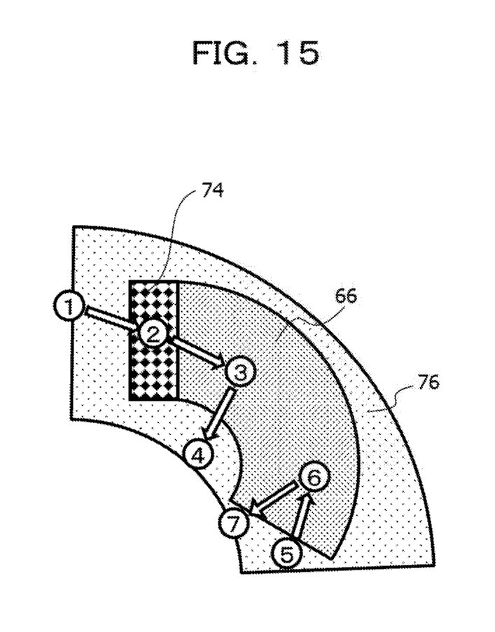

For example, as illustrated in FIG. 15, if the position of an object represented by the measurement result makes time-series change of 1→2→3→4, the detecting unit 213 detects this object as the instructing body 70 and recognizes a gesture from time-series change in the detection result between 2 and 4. Furthermore, if change in the position of an object represented by the measurement result is 5→6→7, the detecting unit 213 does not detect this object as the instructing body 70 because the object does not pass through the gesture start preparation region 74 when entering the gesture region 66.

The detection device 210 included in the mounted equipment 16 may be implemented by the computer 40 illustrated in FIG. 7, for example. In the storing unit 43 of the computer 40, a detection program 250 for causing the computer 40 to function as the detection device 210 is stored. The detection program 250 includes the acquisition process 51, a setting process 252, and a detection process 253.

The CPU 41 reads out the detection program 250 from the storing unit 43 and loads the detection program 250 into the memory 42 to sequentially execute the processes the detection program 250 has. The CPU 41 operates as the acquiring unit 11 illustrated in FIG. 1 by executing the acquisition process 51. Furthermore, the CPU 41 operates as the setting unit 212 illustrated in FIG. 1 by executing the setting process 252. Moreover, the CPU 41 operates as the detecting unit 213 illustrated in FIG. 1 by executing the detection process 253. This causes the computer 40 that executes the detection program 250 to function as the detection device 210.

It is also possible that functions implemented by the detection program 250 are implemented by a semiconductor integrated circuit for example, an ASIC or the like for more detail.

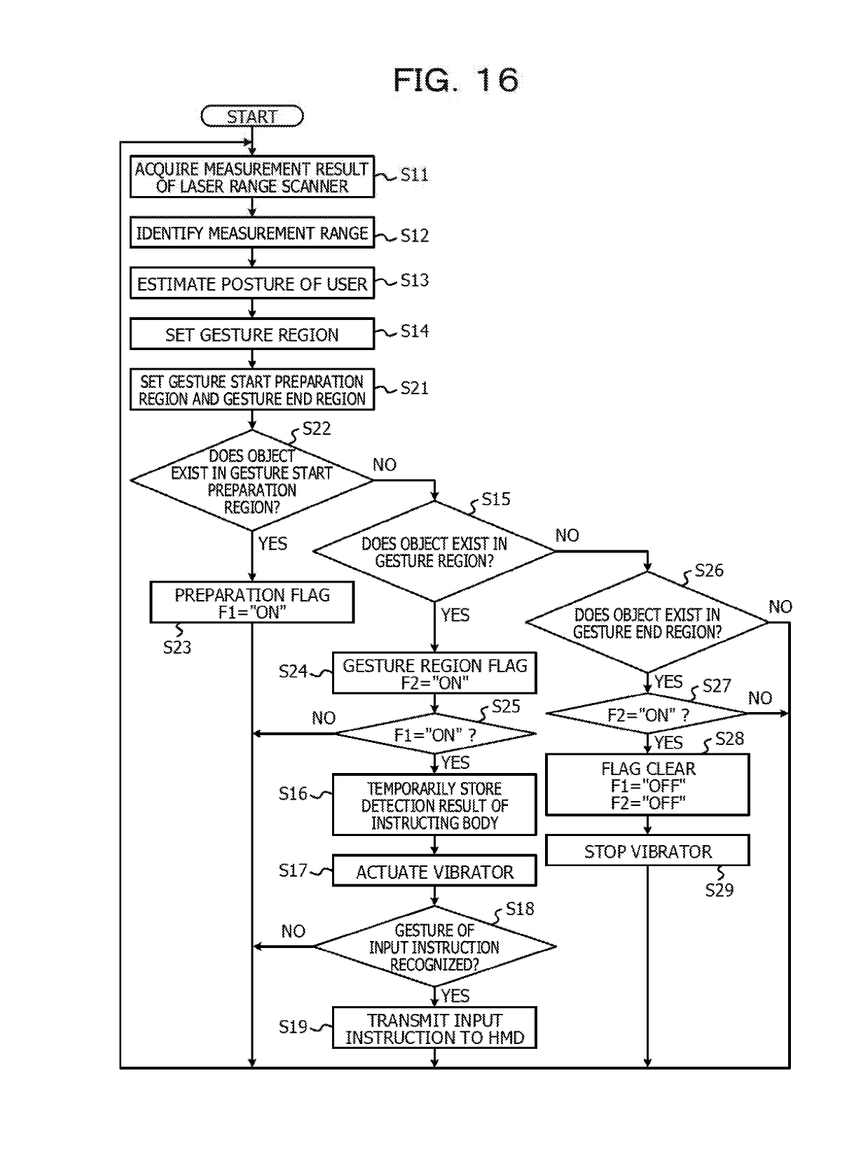

Next, operation of the gesture input system 200 according to the second embodiment will be described. In the second embodiment, detection processing illustrated in FIG. 16 is executed in the detection device 210. Regarding the detection processing in the second embodiment, the processing similar to the detection processing (FIG. 8) in the first embodiment is given the same numeral and detailed description of the processing is omitted.

First, the steps S11 to S14 are carried out and the gesture region 66 is set in the measurement range 62. Then, in the next step S21, the setting unit 212 sets the gesture start preparation region 74 and the gesture end region 76.

Next, in a step S22, the detecting unit 213 determines whether or not an object exists in the gesture start preparation region 74 based on the measurement result of the laser range scanner 17 and the gesture start preparation region 74 set in the above-described step S21. If an object exists in the gesture start preparation region 74, the processing makes transition to a step S23 and the detecting unit 213 sets a preparation flag F1 indicating that an object has entered the gesture start preparation region 74 to “ON,” and the processing returns to the step S11.

On the other hand, if an object does not exist in the gesture start preparation region 74, the processing makes transition to the step S15 and the detecting unit 213 determines whether or not an object exists in the gesture region 66. If an object exists in the gesture region 66, the processing makes transition to a step S24. In the step S24, the detecting unit 213 sets a gesture region flag F2 indicating that an object exists in the gesture region 66 to “ON,” and the processing makes transition to a step S25.

In the step S25, the detecting unit 213 determines whether or not the preparation flag F1 is “ON.” In the case of F1=“ON,” the preparation flag F1 indicates that the object has passed through the gesture start preparation region 74 and has entered the gesture region 66. Therefore, the detecting unit 213 detects the object as the instructing body 70 that makes an input instruction and carries out gesture recognition in the subsequent steps S16 to S19. On the other hand, in the case of F1≠“ON,” the preparation flag F1 indicates that the object has entered the gesture region 66 without passing through the gesture start preparation region 74. Therefore, the detecting unit 213 regards the object as an object other than the instructing body 70 or the instructing body 70 that does not intend a gesture of an input instruction, and returns to the step S11 without carrying out gesture recognition.

Furthermore, if the negative determination is made in the step S15, the processing makes transition to a step S26. In the step S26, the detecting unit 213 determines whether or not an object exists in the gesture end region 76 based on the measurement result of the laser range scanner 17 and the gesture end region 76 set in the above-described step S21. If an object exists in the gesture end region 76, the processing makes transition to a step S27.

In the step S27, the detecting unit 213 determines whether or not the gesture region flag F2 is “ON.” In the case of F2=“ON,” the gesture region flag F2 indicates that the instructing body 70 that has existed in the gesture region 66 has moved to the gesture end region 76, and it may be determined that the end of a gesture is intended. Therefore, the processing makes transition to a step S28 and the detecting unit 213 sets both the flags F1 and F2 to “OFF.” Furthermore, in a step S29, the detecting unit 213 stops the vibrator 18 in actuation and the processing returns to the step S11.

On the other hand, in the case of F2≠“ON,” the object has not moved from the gesture region 66 to the gesture end region 76 and recognition processing of a gesture is not currently being executed. Thus, the processing returns to the step S11 without execution of the processing of the steps S28 and S29.

Furthermore, in the case of the negative determination in the step S26, the object as the processing target does not exist in the measurement range 62 and thus the processing returns to the step S11.

As described above, according to the gesture input system 200 in accordance with the second embodiment, the detection device 210 included in the mounted equipment 16 sets the gesture start preparation region 74 adjacent to the gesture region 66. Furthermore, the detection device 210 executes processing of gesture recognition regarding the instructing body 70 that has passed through the gesture start preparation region 74 and has entered the gesture region 66. This may reduce processing of unnecessary gesture recognition in the case in which an object other than the instructing body 70 or the instructing body 70 that does not intend a gesture of an input instruction enters the gesture region 66.

### Third Embodiment

Next, a third embodiment will be described. Regarding a gesture input system according to the third embodiment, the part similar to that of the gesture input system 100 according to the first embodiment is given the same numeral and detailed description of the part is omitted.

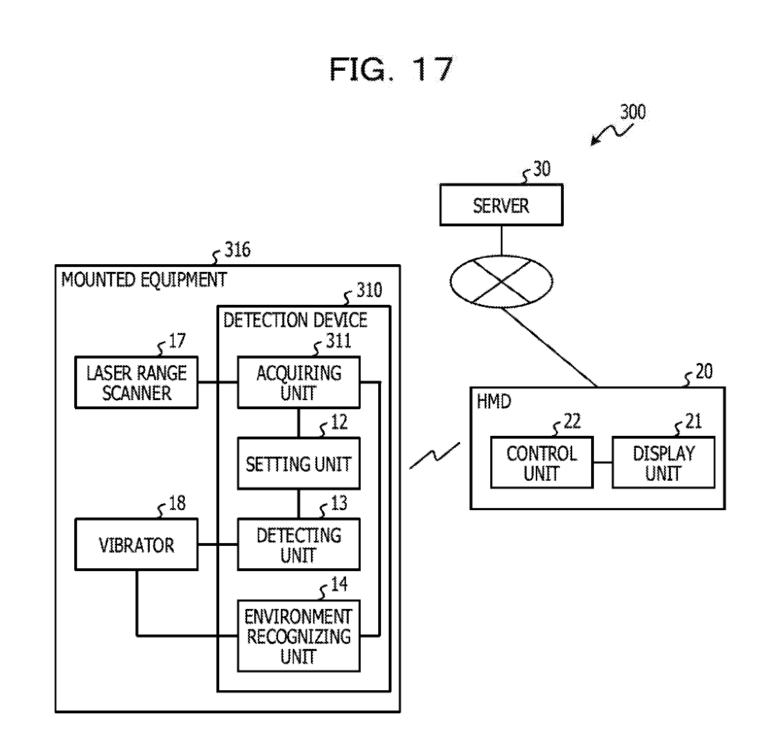

As illustrated in FIG. 17, a gesture input system 300 according to the third embodiment includes mounted equipment 316, the HMD 20, and the server 30. The mounted equipment 316 includes a detection device 310, the laser range scanner 17, and the vibrator 18. The detection device 310 functionally includes an acquiring unit 311, the setting unit 12, the detecting unit 13, and an environment recognizing unit 14.

The acquiring unit 311 accepts a measurement result output from the laser range scanner 17 and transfers the measurement result to the setting unit 12. In addition, the acquiring unit 311 transfers the measurement result also to the environment recognizing unit 14.

The environment recognizing unit 14 recognizes the surrounding environment of the user 60 based on the measurement result of the laser range scanner 17. For the environment recognition, measurement results of the whole of the measurement range 62 are used. Furthermore, if a hazardous place defined in advance is included in the recognized surrounding environment, the environment recognizing unit 14 vibrates the vibrator 18 in order to inform the user 60 of the existence of the hazardous place.

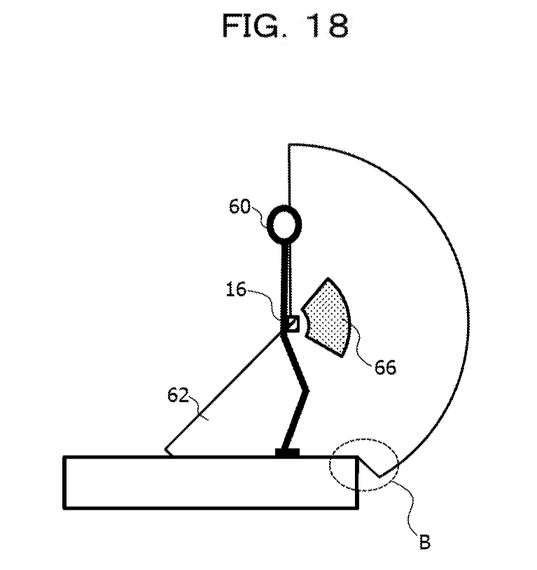

As the hazardous places, a step in a floor, an obstacle existing in the traveling direction, and so forth are envisaged, for example. In the measurement result of the laser range scanner 17, the shapes of objects existing in the surroundings may be recognized. Thus, patterns of the shapes representing the hazardous places are defined in advance. Furthermore, the environment recognizing unit 14 may detect the hazardous places by comparing the measurement result of the laser range scanner 17 and the patterns defined in advance. Moreover, for example, the value of the measurement result suddenly changes at a step part in a floor as illustrated in a part of an ellipse B in FIG. 18. Thus, the environment recognizing unit 14 may detect the hazardous places based on such a change in the value of the measurement result.

The detection device 310 included in the mounted equipment 16 may be implemented by the computer 40 illustrated in FIG. 7, for example. In the storing unit 43 of the computer 40, a detection program 350 for causing the computer 40 to function as the detection device 310 is stored. The detection program 350 includes an acquisition process 351, the setting process 52, the detection process 53, and an environment recognition process 54.

The CPU 41 reads out the detection program 350 from the storing unit 43 and loads the detection program 350 into the memory 42 to sequentially execute the processes the detection program 350 has. The CPU 41 operates as the acquiring unit 311 illustrated in FIG. 17 by executing the acquisition process 351. Furthermore, the CPU 41 operates as the environment recognizing unit 14 illustrated in FIG. 17 by executing the environment recognition process 54. The other processes are similar to the detection program 50 according to the first embodiment. This causes the computer 40 that executes the detection program 350 to function as the detection device 310.

It is also possible that functions implemented by the detection program 350 are implemented by a semiconductor integrated circuit for example, an ASIC or the like for more detail.

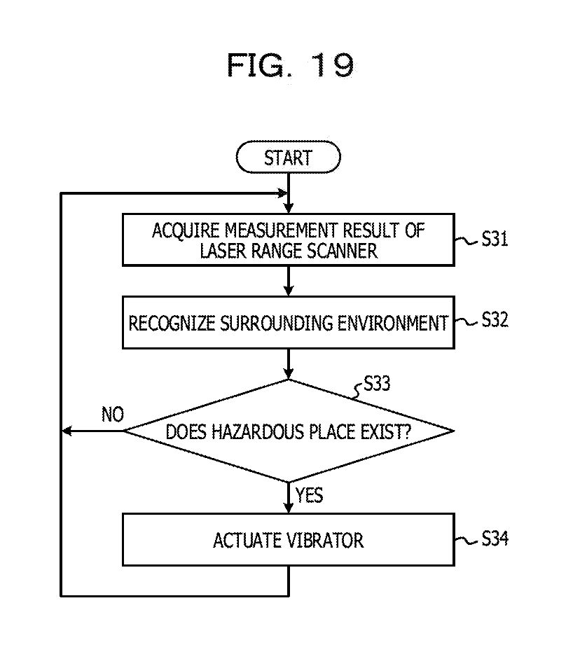

Next, operation of the gesture input system 300 according to the third embodiment will be described. In the third embodiment, in the detection device 310, the detection processing similar to the detection processing (FIG. 8) in the first embodiment is executed and environment recognition processing illustrated in FIG. 19 is executed.

First, in a step S31, the acquiring unit 311 accepts a measurement result output from the laser range scanner 17 and transfers the measurement result to the environment recognizing unit 14. Next, in a step S32, the environment recognizing unit 14 recognize the surrounding environment of the user 60 based on the measurement result of the laser range scanner 17. Next, in a step S33, the environment recognizing unit 14 determines whether or not a hazardous place defined in advance is included in the recognized surrounding environment. If a hazardous place is included in the surrounding environment, the processing makes transition to a step S34 and the vibrator 18 is vibrated in order to inform the user 60 of the existence of the hazardous place. Then, the processing returns to the step S31. On the other hand, if a hazardous place is not included in the surrounding environment, the processing returns to the step S31 without execution of the step S34.

As described above, according to the gesture input system 300 in accordance with the third embodiment, the configuration used for gesture recognition may be used also for recognition of the surrounding environment of the user 60.

In the third embodiment, the case in which hazardous places are detected based on the recognized surrounding environment is described. However, the configuration is not limited to the case. For example, the surrounding environment recognized from a measurement result of the laser range scanner 17 may be collated with known environment data to estimate the position of the user 60 in the environment.

Furthermore, in the third embodiment, an example of the detection device 310 obtained by adding the environment recognizing unit 14 to the detection device 10 according to the first embodiment is described. However, a configuration obtained by adding the environment recognizing unit 14 to the detection device 210 according to the second embodiment may be employed.

Furthermore, in the above-described respective embodiments, the case in which the laser range scanner 17 of a plane scanning type is used is described. However, the configuration is not limited to the case. A laser range scanner of a three-dimensional scanning type that emits light while an emitting unit obtained by arranging plural light sources in the direction orthogonal to the scanning direction is scanned in the scanning direction may be used. In this case, the gesture region 66 may also be set as a three-dimensional region.

In addition, in the above-described respective embodiments, the case of a hand part of the user 60 is described as one example of the instructing body 70 that makes an input instruction. However, the instructing body 70 may be another region of the user 60 such as a foot. Furthermore, if the user 60 makes gesture input while holding an instructing bar or the like, the instructing bar may be detected as the instructing body 70.

Moreover, in the above-described respective embodiments, the case in which the posture of a user 60 is estimated by using a measurement result of the laser range scanner 17 is described. However, the configuration is not limited to the case. A posture sensor consisting of an acceleration sensor, a gyro sensor, or the like may be mounted on the user 60 and the posture of the user 60 may be estimated based on a sensor value detected by the posture sensor. The posture sensor may be mounted on the user 60 separately from the mounted equipment 16 or a configuration in which the posture sensor is included in the mounted equipment 16 may be employed.

Furthermore, in the above-described respective embodiments, the case in which the mounting position of the mounted equipment 16 is the body trunk 60A (waist) of the user 60 is described. However, the mounted equipment 16 may be mounted on another region such as the head, the chest, or an arm. However, in the head, an arm, or the like, the flexibility in the region itself (movable range when the position of the user 60 is fixed) is high. Therefore, when the mounted equipment 16 is mounted, variation in the positional relationship between the mounted equipment 16 and the position at which the instructing body 70 makes a gesture (for example, position the right hand is able to reach) also becomes large. In the case of mounting the mounted equipment 16 on such a region having high flexibility, the gesture region 66 is set in consideration also of variation in the position at which the mounted equipment 16 is mounted. If the mounted equipment 16 is mounted on the body trunk 60A as in the above-described embodiments, variation in the position at which the mounted equipment 16 is mounted is small and thus the instructing body 70 may be detected more stably.

In the above-described respective embodiments, the modes in which the detection programs 50, 250, and 350 are stored (installed) in the storing unit 43 in advance are described. However, the configuration is not limited to the modes. It is also possible to provide the detection programs according to the disclosed techniques in a form of being recorded on a recording medium such as a compact disc read-only memory (CD-ROM), a digital versatile disc (DVD)-ROM, or a universal serial bus (USB) memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A detection device comprising:
a sensor configured to emit a light and detect an object by detecting the light reflected from the object; and
a processor configured to determine, when the object is detected in a first region that is narrower than a range where the light reaches, a motion of the object to be a gesture input for the detection device.

2. The detection device according to claim 1, wherein
when a user wears the detection device, the processor is configured to set the first region to be a region where a part of a body of the user or a specified object held by the user reaches.

3. The detection device according to claim 2, wherein
the first region is set based on a position in the body of the user at which the detection device is worn.

4. The detection device according to claim 2, wherein
the detection device is worn on a trunk of the body of the user.

5. The detection device according to claim 2, wherein
the first region is set based on posture of the user.

6. The detection device according to claim 1, wherein
the processor is configured to determine the gesture input for the detection device based on a time-series change in at least one of shape and position of the object in the first region.

7. The detection device according to claim 1, wherein
the processor is configured to set a second region in contact with the first region, and determine, when detecting the object that moves from the second region to the first region, the motion of the object to be the gesture input for the detection device.

8. The detection device according to claim 1, wherein
the processor is configured to set a third region in contact with the first region, and stop determining, when detecting the object that moves from the first region to the third region, the motion of the object to be the gesture input for the detection device.

9. The detection device according to claim 1, wherein
the processor configured to recognize a surrounding environment of the detection device based on the detected object.

10. The detection device according to claim 9, wherein
the processor configured to determine whether a surrounding environment of the detection device is dangerous by comparing the detected object with a specified shape.

11. The detection device according to claim 9, wherein
the processor configured to determine a position of the detection device in the surrounding environment by comparing the detected object with a specified shape.

12. The detection device according to claim 1, wherein
the gesture input is used for operating an operation screen of a display of another device worn by the user.

13. A detection method comprising:
emitting, by a detection device, a light and detect an object by detecting the light reflected from the object; and
determining, when the object is detected in a first region that is narrower than a range where the light reaches, a motion of the object to be a gesture input for the detection device.

14. A non-transitory computer readable storage medium that stores an detection program that causes a computer to execute a process comprising:
emitting, by a detection device, a light and detect an object by detecting the light reflected from the object; and
determining, when the object is detected in a first region that is narrower than a range where the light reaches, a motion of the object to be a gesture input for the detection device.
